(19) United States
(12) Patent Application Publication
(10) Pub. No.: US 2026/0369541 A1
(43) Pub. Date: Nov. 19, 2026

(54) SYSTEMS AND METHODS FOR MASS SPECTROMETRY WITH IMPROVED PRODUCT ION YIELD

(71) Applicant: Thermo Finnigan LLC, San Jose, CA (US)

(72) Inventor: Christopher Mullen, Menlo Park, CA (US)

(21) Appl. No.: 19/210,282

(22) Filed: May 16, 2025

(51) Int. Cl. H01J 49/42; H01J 49/36

(52) U.S. Cl. CPC H01J 49/4225; H01J 49/36

(57) ABSTRACT

A system for mass spectrometry directs an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjusts, over a time period during which the plurality of packets of ions arrive at the collision cell, a collision energy of the collision cell based on the distinct m/z of each packet of ions and the distinct arrival time of each packet of ions at the collision cell.

### BACKGROUND INFORMATION

A mass spectrometer is a sensitive instrument that may be used to detect, identify, and/or quantify molecules based on the mass-to-charge ratio (m/z) of ions produced from the molecules. A mass spectrometer generally includes an ion source for producing ions from molecules included in a sample, a mass analyzer for separating the ions based on their m/z, and an ion detector for detecting the separated ions. The mass spectrometer may include or be connected to a computer-based software platform that uses data from the ion detector to construct a mass spectrum that shows a relative abundance of each of the detected ions as a function of m/z. The mass spectrum may be used to detect and quantify molecules in simple and complex mixtures. A separation system, such as a liquid chromatography (LC) system, gas chromatography (GC) system, or capillary electrophoresis (CE) system, may be coupled to the mass spectrometer in a combined system (e.g., LC-MS, GC-MS, or CE-MS system) to separate components in the sample before the components are introduced to the mass spectrometer.

One application of mass spectrometry is the identification, quantification, and structural elucidation of peptides, proteins, and related molecules in complex biological samples. In some such experiments, often referred to as tandem mass spectrometry (MS/MS or MS2) or multi-stage mass spectrometry (MSn where n is 2 or more), certain ions are fragmented in a controlled manner to yield product ions. A mass analysis (referred to as an MS/MS, MS2, or MSn analysis) is then performed on the product ions to generate mass spectra of the product ions. The mass spectra of the product ions provide information that may be used to confirm identification, determine quantity, and/or derive structural details regarding analytes of interest.

Various techniques may be used to acquire mass spectra using tandem mass spectrometry (MS/MS or MS2) and multi-stage mass spectrometry (MSn). One commonly used technique is data-dependent acquisition (DDA), which uses data acquired in one mass analysis to select, based on predetermined criteria, one or more ion species or a narrow m/z range for mass isolation and fragmentation. For example, the mass spectrometer may perform a full MS survey scan of precursor ions over a wide precursor m/z range and then select one or more precursor ion species from the resulting spectra for subsequent MS/MS or MSn analysis. The criteria for selection of precursor ion species may include intensity, charge state, m/z, inclusion/exclusion lists, or isotopic patterns. The main disadvantage of the DDA technique is the inherently random nature of the results. When technical replicates of the same sample or comparative analysis on other samples is performed, some analytes may be measured in one experiment but not in others. This frustrates attempts to perform reproducible analyses and is known as the “missing value problem”.

In contrast to DDA, data-independent acquisition (DIA) is a technique in which all precursor ion species within a wide precursor m/z range (e.g., 500-900 m/z) are isolated and fragmented via a sequentially advancing isolation window of a fixed m/z width (e.g., 20 m/z) to generate product ions. An MS2 or MSn analysis is then performed on the product ions in a methodical and unbiased manner. The acquisition of the set of spectra spanning the full precursor m/z range constitutes one cycle, which is repeated to generate MS2 or MSn mass spectra of the product ions. The cycle time, or time required to acquire the spectra in a cycle, is typically set such that at least a certain number of cycles will be executed per chromatography peak width, such that area of the peaks may be properly integrated. In the DIA technique, isolation and fragmentation of one or more precursor ion species is not dependent on data acquired in a survey mass analysis, as in DDA, and is much more suitable for comparing results across different samples than DDA.

In contrast to DDA and DIA, targeted mass spectrometry performs analysis of a fixed list of analytes. Targeted mass spectrometry comes in many forms, such as selected reaction monitoring (SRM), multiple reaction monitoring (MRM), and parallel reaction monitoring (PRM). Generally, the introduction of the sample to the mass spectrometer is performed using a separation system (e.g., a liquid chromatography system). To increase experiment capacity, the operator schedules analysis of each analyte only during a narrow period of time around the characteristic elution times of each analyte of interest. Targeted mass spectrometry is advantageous because of the high data quality that can be produced when the instrument is dedicated to the analysis of a smaller group of analytes of interest, each with a narrow or even customized precursor isolation window. Narrow scheduled windows may produce results with low limits of detection and high dynamic range and allow an increased number of targets in an assay.

The selective detection and quantitation of a specific analyte of interest in a complex mixture is often very difficult, even with targeted acquisition. For example, in proteomics research, a peptide of interest may be included in a complex biological matrix composed of a mixture of tens of thousands of peptides with abundances spanning many orders of magnitude. Tandem mass spectrometry (MS2) may be used for the quantitation of a molecule in a complex mixture. For example, in a refined targeted acquisition technique known as internal standard triggered-parallel reaction monitoring (IS-PRM), a sample containing a peptide target may be spiked with a known amount of the corresponding internal standard (IS) (e.g., a synthetic peptide with the same amino acid sequence but containing heavy stable isotope(s)) and scanned by the instrument in a dual-mode combining single stage and tandem mass spectrometry. Detection of the internal standard triggers the mass spectrometer to monitor for the specific peptide target of interest.

Multiplexing with the use of isobaric mass tags, such as Tandem Mass Tag® (TMT®) reagents (produced by Electrophoretics Limited and available from Thermo Fisher Scientific™, Waltham, MA) and/or isobaric tags for relative and absolute quantitation (iTRAQ®) (AB Sciex Pte. Ltd.), may increase sample throughput. Isobaric mass tags are compounds that react with and attach to analytes, such as peptides. Isobaric mass tags have a reporter region, a balance region, and a reactive group (e.g., an amine-reactive group, a cysteine-reactive group, or a carbonyl-reactive group). Versions of isobaric mass tags have been created that all have the same exact total mass of reporter region plus balance region, but the reporter region mass and the balance region mass for each version is different using various different combinations and positions of stable isotopes (e.g., ¹³C and ¹⁵N isotopes). Multiple individual samples may be multiplexed by labeling analytes (e.g., peptides) in each sample with a different version of the isobaric mass tag, combining all the samples together, and analyzing the combined samples via LC-MS or GC-MS in one experiment. The isobaric labelled peptides with common sequence across the various individual samples all have the same m/z, but when they are fragmented by MS2, the reporter regions of the isobaric mass tags fall off and become reporter ions, which may have different m/z values and may be analyzed by MS2. The relative intensity of the reporter ions at their various m/z are indicative of the relative concentrations of the analytes in each individual sample.

However, every isobaric mass tag-labeled analyte in a particular individual sample fragments to form the same reporter ions. Thus, when quantitating a particular target analyte in a sample, reporter ions from other non-target (contaminating or background) analytes that co-elute and are co-isolated with the target analyte may also be detected, leading to so-called “ratio distortion” and inaccurate quantitation of the target analyte. These problems have been addressed by performing targeted MS/MS/MS (MS3) analyses to analyze the isobaric mass tag-labeled target analytes.

For example, periodic MS survey scans may be performed, and any precursor ions that meet certain criteria are flagged and trigger MS2 analyses on those ions. If the MS2 mass spectra indicate the presence of product ions that are likely to have isobaric mass tags, the MS2 product ions are then isolated and fragmented, releasing the reporter ions as second generation product ions. The m/z of the reporter ions is then measured using a targeted MS3 analysis. This double-filtering process removes contaminant and background analytes prior to detection of the reporter ions. Thus, a targeted MS3 analysis may be performed by using an MS2 DDA analysis.

A conventional implementation of a multiplex targeted MS3 analysis using isobaric mass tags is the “triggered by offset, multiplexed, accurate-mass, high-resolution, and absolute quantification” (TOMAHAQ) method. This method uses spiked-in internal standard peptides at high concentration to be detected in the MS survey scan, an MS2 DDA confirming scan, and a quantifying targeted MS3 scan. The peptides in each sample, including the internal standard peptides, are labeled with an isobaric mass tag. Although useful in certain cases, the reliance on internal standards makes it prohibitively expensive and complex, and the method may not be sufficiently effective on linear ion trap mass analyzers.

Another conventional implementation of a multiplex targeted MS3 analysis using isobaric mass tags is Barshop's Sequential Windows Acquisition of Reporter Masses for Quantitation-First. In this approach, a sample is first characterized by low-accuracy MS2 data-independent acquisition (DIA) analyses to find regions of time and m/z that contain reporter ions with nominally large fold changes. A targeted MS2 analysis is then performed that scans for certain m/z windows and times, and then a data-dependent multiplexed MS3 analysis is performed for any MS2 mass spectra with fragments that meet certain criteria. This method does not rely on internal standards like TOMAHAQ, but its reliance on MS2 reporter ion measurements to make decisions about what to target in MS3 could be misguided or too narrowing. Moreover, the use of data dependence may still lead to the “missing values” problem in which certain analytes cannot be identified or quantified in certain samples due to the stochastic nature of DDA.

Another conventional implementation of the multiplex targeted MS3 concept using isobaric mass tags is synchronous precursor selection (SPS) MS3. SPS MS3 was developed to avoid both ratio distortion and the loss in sensitivity of other MS3 techniques. SPS MS3 uses isolation waveforms with multiple frequency notches for synchronous precursor selection of multiple MS2 product ions. The selected MS2 product ions—the MS3 precursor ions—are fragmented to produce a reporter ion population (MS3 product ions) that is far more intense than the population that would have been produced by fragmenting only a single MS2 product ion. At the same time, the selectivity of the standard MS3 method is maintained by carefully defining the isolation notches of the SPS isolation waveform to ensure high isolation specificity of the target MS2 fragment ions. Nevertheless, there is room to improve sensitivity in SPS MS3 experiments.

### SUMMARY

The following description presents a simplified summary of one or more aspects of the methods and systems described herein to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the methods and systems described herein in a simplified form as a prelude to the more detailed description that is presented below.

In some illustrative examples, a system for mass spectrometry includes one or more processors and memory storing executable instructions that, when executed by the one or more processors, cause a computing device for mass spectrometry to perform a process including: directing an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjusting, over a time period during which the plurality of packets of ions arrive at the collision cell, a collision energy of the collision cell based on the distinct m/z of each packet of ions and the distinct arrival time of each packet of ions at the collision cell.

In some illustrative examples, a mass spectrometer includes an ion trap, a collision cell, and a controller configured to: direct an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjust, over a time period during which the plurality of packets of ions arrive at the collision cell, a collision energy of the collision cell based on the distinct m/z of each packet of ions and the distinct arrival time of each packet of ions at the collision cell.

In some illustrative examples, a non-transitory computer-readable medium stores instructions that, when executed, direct at least one processor of a computing device for mass spectrometry to perform a process including: directing an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjusting, over a time period during which the plurality of packets of ions arrive at the collision cell, a collision energy of the collision cell based on the distinct m/z of each packet of ions and the distinct arrival time of each packet of ions at the collision cell.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows an illustrative schematic diagram of a mass spectrometer suitable for performing the methods described herein.

FIG. 2 shows a functional diagram of an illustrative implementation of a controller of the mass spectrometer of FIG. 1.

FIG. 3 shows an illustrative method of performing an MS3 analysis of a sample using the mass spectrometer of FIG. 1.

FIG. 4 shows a graph that illustrates the m/z dependence of offset voltage.

FIG. 5 shows an illustrative method of dynamically setting the offset voltage of a collision cell based on m/z of ions as the ions arrive at the collision cell.

FIG. 6 shows a graph that illustrates the m/z-dependence of the flight time of multiple distinct packets of ions from a high pressure trap to an ion routing multipole of the mass spectrometer of FIG. 1.

FIG. 7 shows a graph that plots arrival time of co-eluted ions at the collision cell as a function of m/z.

FIG. 8A shows an illustrative graph including a curve that plots the amplitude of the applied RF voltages to a transfer lens as a function of time.

FIG. 8B shows an illustrative graph including an elution curve that plots the amplitude of the applied RF voltages to a transfer lens as a function of time.

FIG. 9A shows an illustrative offset voltage schedule for continuously adjusting the offset voltage of the collision cell over time.

FIG. 9B shows an illustrative offset voltage schedule for stepping the offset voltage of the collision cell over time.

FIG. 10 shows an illustrative computing system.

### DETAILED DESCRIPTION

Systems, apparatuses, and methods for mass spectrometry with improved product ion yield are described herein. In some examples, a system for mass spectrometry directs an ion trap to transfer a plurality of packets of ions accumulated in the ion trap to a collision cell. Each packet of ions of the plurality of packets of ions has a distinct mass-to-charge ratio (m/z) and a distinct arrival time at the collision cell. The system dynamically adjusts, over a time period during which the plurality of packets of ions arrive at the collision cell, a collision energy of the collision cell based on the distinct m/z of each packet of ions and the distinct arrival time of each packet of ions at the collision cell. Some implementations of the improved systems and methods are based on an m/z-dependent arrival time at the collision cell of the plurality of packets of ions co-isolated by a single ejection event (e.g., by synchronous precursor selection in an SPS MS3 experiment). Other implementations are based on a controlled elution of the plurality of packets of ions from the ion trap over time in a plurality of distinct ejection events, wherein one or more packets of ions are ejected in distinct ejection events. In either case, because the arrival time of precursor ions at the collision cell is m/z dependent and the optimum collision energy for ion activation is m/z dependent, the collision energy of the collision cell can be dynamically adjusted over time in synchronization with m/z of the arriving packets of ions to optimize activation of the precursor ions (e.g., to maximize product ion yield).

Synchronization of the m/z-dependent collision energy with m/z of the arriving packets of ions increases product ion yield in the collision cell as compared with traditional mass spectrometry methods. In SPS MS3 experiments, the reporter ion yield (measured as the ratio of product reporter ions to unconverted precursor ions) is increased as compared to conventional SPS MS3 techniques, resulting in improved sensitivity and improved signal-to-noise ratio. The improved systems and methods are not limited to SPS MS3, but may be performed in any experiment where a population of cooled, trapped ions need to undergo activation by higher-energy collisional dissociation (HCD), such as in multiplexed MS2 experiments where ions are isolated sequentially (as by a quadrupole mass filter) or concurrently (as with a multi-frequency notch isolation waveform).

Various embodiments will now be described in more detail with reference to the figures. The systems and methods described herein may provide one or more of the benefits mentioned above and/or various additional and/or alternative benefits that will be made apparent herein.

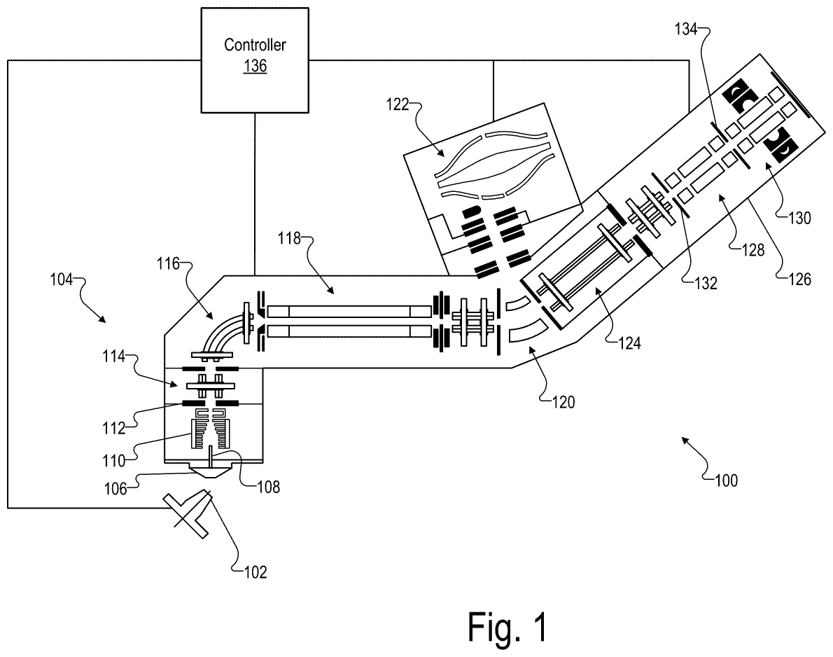

In some examples, SPS MS3 is performed on a Tribrid™ mass spectrometer from Thermo Fisher Scientific™. FIG. 1 shows an illustrative schematic diagram of the Orbitrap™ Fusion™ Lumos™ Tribrid™ mass spectrometer (Thermo Fisher Scientific™), which is suitable for performing the methods described herein. It is noted that the Orbitrap™ Fusion™ Lumos™ or other Tribrid™ mass spectrometer is not essential to the present disclosure and other mass spectrometers that permit SPS isolation of MS2 product ions followed by an m/z-dependent collision-based MS3 analysis may be used.

Mass spectrometer 100 includes an ionization source 102 that forms gas phase sample ions from biomolecules that are contained in solution. In the example of FIG. 1 ionization source 102 is an atmospheric pressure ionization (API) source, such as an electrospray ionization (ESI) source. In general, ions can be generated from peptides by any of the following ionization techniques: electrospray ionization (ESI), atmospheric pressure chemical ionization (APCI), atmospheric pressure photoionization (APPI), atmospheric pressure gas chromatography (APGC) with glow discharge, AP-MALDI, laser desorption (LD), inlet ionization, DESI, laser ablation electrospray ionization (LAESI), inductively coupled plasma (ICP), laser ablation inductively coupled plasma (LA-ICP), etc. Any of these ion sources can be interfaced to a sample separation device upstream of the ion source, such as a liquid chromatography (LC) system, ion chromatography (IC) system, gas chromatography (GC) system, capillary zone electrophoresis (CZE) system, two dimensional GC (GC×GC) system, or a two dimensional LC (LC×LC) system, which are all herein termed chromatographic devices. The ionization source 102 produces precursor ions of the biomolecules provided by a chromatographic device.

Mass spectrometer 100 further includes source injection optics 104 through which precursor ions pass. The source injection optics 104 can include an inlet 106, a capillary transfer tube 108, an electrodynamic ion funnel 110, a lens 112, an injection flatapole 114, and a bent ion guide 116. Source injection optics 104 may include any other suitable components not shown.

A mass filter 118 is configured to select a mass range of the precursor ions in a variable mass isolation window that is narrower than the full mass range of precursor ions from the ionization source. Mass filter 118 can also be operated to transmit a full mass range of precursor ions, such as for a survey scan in MS1 mode. Mass filter 118 is a quadrupole or other multipole mass selective device.

A curved linear ion trap (C-trap) 120 is configured to apply axial trapping voltages to accumulate ions. C-trap 120 can inject the accumulated ions into mass analyzer 122 for acquisition of mass spectra. In MS1 mode, accumulated ions are injected into mass analyzer 122 for acquisition of high resolution MS1 spectra. In MS2 mode, precursor ions that have been mass selected by mass filter 118 are transmitted through C-trap 120 by modifying the axial trapping voltages to permit transmission into ion routing multipole 124.

Ion routing multipole 124 is implemented by a linear multipole device and can be operated in different modes to serve different functions. In ion dissociation modes, ion routing multipole 124 operates as a collision cell to fragment precursor ions by collision induced dissociation (CID) or higher-energy collisional dissociation (HCD) to produce product ions. (Fragmentation is also referred to as “activation” of the ions.) The ions are fragmented in the presence of an inert collision gas (e.g., helium, nitrogen, or argon) by applying a DC offset voltage to ion routing multipole 124. The offset voltage sets the collision energy for ion routing multipole 124. The offset voltage may be adjusted depending on m/z of the precursor ions to be fragmented. Ions of higher m/z generally require greater collision energy to induce fragmentation. A higher offset voltage leads to more energetic collisions, resulting in greater fragmentation of precursor ions. In ion routing modes, ion routing multipole 124 operates as an ion guide to guide ions without inducing ion dissociation. For example, after fragmenting precursor ions to produce product ions, ion routing multipole 124 may trap and store the product ions in a low energy state and/or guide the product ions to linear ion trap mass analyzer 126 or guide the product ions back to C-trap 120. In other examples, ion routing multipole 124 may guide precursor ions and/or product ions from linear ion trap mass analyzer 126 to C-trap 120, and vice versa.

Linear ion trap mass analyzer 126 is a dual cell linear quadrupole ion trap that includes two traps in series: a high pressure trap 128 and a low pressure trap 130. High pressure trap 128 is a linear quadrupole (or other multipole) ion trap that is configured to isolate precursor ions and dissociate precursor ions, such as by CID or ETD. Ion activation is more efficient at high pressure, so high pressure trap 128 is operated at high pressure. Low pressure trap 130 is a linear quadrupole (or other multipole) ion trap mass analyzer configured to trap and mass analyze ions. The peak width of mass spectral peaks is generally proportional to pressure, so low pressure trap 130 is operated at low pressure so that pressure does not significantly affect peak widths.

A transfer lens 132 is positioned between linear ion trap mass analyzer 126 and ion routing multipole 124. A combination of RF voltages and DC voltages may be applied to linear ion trap mass analyzer 126 (e.g., to high pressure trap 128) to trap ions having an m/z above a threshold m/z value (e.g., a low mass cutoff value) within a trapping volume. The DC voltages applied to linear ion trap mass analyzer 126 generate a DC electric field that exerts forces on the ions trapped in linear ion trap mass analyzer 126 (e.g., in high pressure trap 128) to urge the ions to migrate out of linear ion trap mass analyzer 126 (toward ion routing multipole 124). A DC voltage may be applied to transfer lens 132 to facilitate transfer of ions from linear ion trap mass analyzer 126 to ion routing multipole 124. In some examples, as will be described below in more detail, RF voltages may also be applied to transfer lens 132 to control the transfer of ions to ion routing multipole 124. The DC voltages and/or RF voltages applied to linear ion trap mass analyzer 126 and/or transfer lens 132 can be adjusted as desired to control the trapping of ions within linear ion trap mass analyzer 126 and ejection and transfer of ions from linear ion trap mass analyzer 126 to ion routing multipole 124. In some examples, ejection and transfer of ions may be controlled by dynamically adjusting the RF voltages applied to transfer lens 132 to dynamically adjust the m/z range of values that are transferred. The DC voltages applied to high pressure trap 128 and transfer lens 132 can be set to urge all precursor ions out of high pressure trap 128 and the RF voltages applied to transfer lens 132 are initially set high and then decreased (e.g., ramped or stepped down) over time. In other examples, ejection and transfer of ions may be controlled by fixing the RF voltages applied to transfer lens 132 and dynamically adjusting (e.g., ramping or stepping) the DC voltages applied to high pressure trap 128 and/or transfer lens 132 to dynamically urge trapped ions to migrate out of high pressure trap 128. In yet further examples, ejection of ions may be controlled by a combination of dynamically adjusting the RF voltages applied to transfer lens 132 and dynamically adjusting the DC voltages applied to high pressure trap 128 and transfer lens 132.

Alternatively to fragmenting ions at ion routing multipole 124, precursor ions may instead be fragmented at linear ion trap mass analyzer 126 by transferring precursor ions between high pressure trap 128 and low pressure trap 130. For example, precursor ions may be trapped in low pressure trap 130 (instead of in high pressure trap 128 as described above) and transferred to high pressure trap 128 for dissociation in high pressure trap 128, which functions as a collision cell. A lens 134 positioned between high pressure trap 128 and low pressure trap 130 may control the transfer of ions between high pressure trap 128 and low pressure trap 130. For example, DC voltages or a combination of RF voltages and DC voltages may be applied to lens 134 and adjusted in the same manner as described above for transfer lens 132 to control the transfer of ions from low pressure trap 128 to high pressure trap 128.

Mass analyzer 122 is an Orbitrap® mass analyzer (Thermo Fisher Scientific™, Waltham, MA). Mass analyzer 122 traps one or more ions within a trapping region and establishes a trapping field within the trapping region that causes the trapped ions to undergo oscillatory motion. The oscillatory motion of ions induces a current in the detector electrodes. A signal measured in time, referred to as a transient, is Fourier transformed to obtain an FT spectrum. An ion's oscillation frequency is a function of the ion's mass and, hence, m/z. Thus, each spectral component (peak) in the FT spectrum corresponds to a particular oscillation frequency of a trapped ion, from which m/z of the ion may be unambiguously determined. In other implementations, mass analyzer 122 may be any other type of mass analyzer, including other electrostatic trap mass analyzers (e.g., an orbital electrostatic trap such as a Kingdon trap, etc.), a Fourier transform ion cyclotron resonance (FT-ICR) mass analyzer, a quadrupole mass analyzer, an ion trap mass analyzer (e.g., a three-dimensional quadrupole ion trap, a cylindrical ion trap, a linear quadrupole ion trap, a toroidal ion trap, etc.), or a time-of-flight (TOF) mass analyzer (e.g., an asymmetric track lossless (Astral™) mass analyzer, from Thermo Fisher Scientific™).

An ion detector in mass analyzers 122 and 126 detects ions at each of a variety of different m/z and responsively generates an electrical signal that is transmitted to a controller 136 for processing, such as to construct a mass spectrum of the analyzed ions. Mass analyzer 122 can be operated in parallel with linear ion trap mass analyzer 126 so that mass analyzer 122 and linear ion trap mass analyzer 126 each acquire a mass spectrum contemporaneously.

Controller 136 is configured to communicate with and control operations of mass spectrometer 100. For example, controller 136 may be configured to control operation of hardware components included in ionization source 102, source injection optics 104, mass filter 118, C-trap 120, mass analyzer 122, ion routing multipole 124, and/or linear ion trap mass analyzer 126. To illustrate, controller 136 may be configured to control an accumulation time of an ion trap (e.g., C-trap 120, mass analyzer 122, ion routing multipole 124, linear ion trap mass analyzer 126), control an oscillatory voltage power source (not shown) and/or a DC power source (not shown) to apply an RF voltage and/or a DC voltage to a hardware component (e.g., to mass filter 118, mass analyzer 122), adjust values of the RF voltage and DC voltage applied to mass filter 118 to select an effective m/z (including a mass tolerance window) for analysis, adjust the sensitivity of ion detectors (e.g., by adjusting the detector gain), set an offset voltage applied to ion routing multipole 124, set a DC voltage for high pressure trap 128, and set an RF voltage applied to transfer lens 132. Controller 136 is also configured to obtain signals and/or data generated or acquired over time by mass spectrometer 100 (e.g., from mass analyzer 122 and/or linear ion trap mass analyzer 126) and uses the data to generate mass spectra data. Mass spectra data represents intensity of the observed signal as a function of m/z. As used herein, “intensity” or “signal intensity” refers to the response of the detector and may represent absolute abundance, relative abundance, ion count, intensity, relative intensity, ion current, or any other suitable measure of ion detection.

As used herein, a “selected m/z” refers to a specific m/z, with or without a mass tolerance window (e.g., +/−0.5 m/z), or a narrow range of m/z (e.g., an isolation window with a width or range such as 20 m/z, 10 m/z, 4 m/z, 3 m/z, etc.). In an MS2 or MSn analysis, such as a data dependent MS2 analysis, a selected reaction monitoring (SRM) analysis, a multiple reaction monitoring (MRM) analysis, or a parallel reaction monitoring (PRM) analysis, the selected m/z corresponds to the m/z of the precursor ion that is isolated and subsequently fragmented to generate reporter ions for relative quantitation.

As used herein, an “acquisition” refers to a mass analysis performed at a discrete point in time to acquire a single mass spectrum, wherein a selected m/z is isolated and fragmented to generate an MS2 or MSn type acquisition. It will be recognized that, in some embodiments, the acquisition is based upon a data-dependent analysis, while in other embodiments it may be a targeted MS2 or data-independent analysis. In other embodiments, there may be multiple rounds of fragmentation and m/z selection, sometimes involving the simultaneous selection of multiple m/z values, all for the sake of performing a higher order MSn acquisition.

Controller 136 may include any suitable computing system(s), hardware (e.g., a processor, circuitry, etc.), and/or software to enable controller 136 to communicate with and control operations of mass spectrometer 100. Controller 136 may also include and/or provide a user interface configured to enable user interaction with mass spectrometer 100. A user may interact with controller 136 via the user interface by tactile, visual, auditory, and/or other sensory type communication. For example, the user interface may include a display device (e.g., liquid crystal display (LCD) display screen, a touch screen, etc.) for displaying information (e.g., mass spectra, notifications, etc.) to the user. The user interface may also include an input device (e.g., a keyboard, a mouse, a touchscreen device, etc.) that allows the user to provide input to controller 136. In other examples, the display device and/or input device may be separate from, but communicatively coupled to, controller 136. For instance, the display device and the input device may be included in a computer (e.g., a desktop computer, a laptop computer, etc.) communicatively connected to controller 136 by way of a wired connection and/or a wireless connection.

While FIG. 1 shows that controller 136 is included in mass spectrometer 100, controller 136 may alternatively be implemented in whole or in part separately from mass spectrometer 100, such as by a computing device communicatively coupled to mass spectrometer 100 by way of a wired connection (e.g., a cable) and/or a wireless or network connection (e.g., a local area network, a wireless network (e.g., Wi-Fi), a wide area network, the Internet, a cellular data network, etc.). Moreover, while FIG. 1 shows only a single controller 136, the controller of mass spectrometer 100 may be implemented in any number of controllers and/or may be distributed across multiple computing systems.

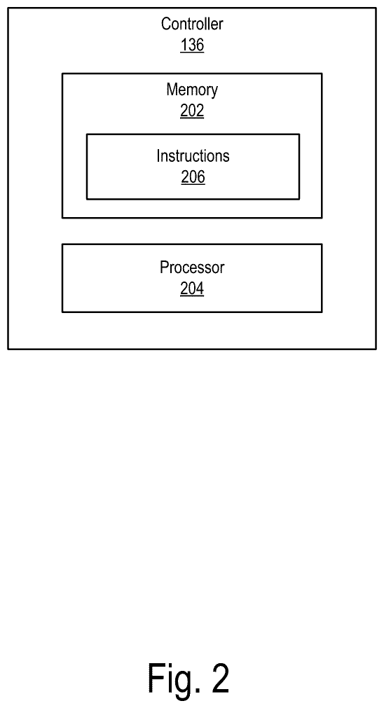

FIG. 2 shows a functional diagram of an illustrative implementation of controller 136. Controller 136 includes, without limitation, a memory 202 and a processor 204 communicatively coupled to one another. Memory 202 and processor 204 may each include or be implemented by hardware and/or software components (e.g., processors, memories, communication interfaces, instructions stored in memory for execution by the processors, etc.). Memory 202 and processor 204 may be distributed between multiple devices and/or multiple locations as may serve a particular implementation.

Memory 202 may maintain (e.g., store) executable data used by processor 204 to perform any of the operations described herein. For example, memory 202 may store instructions 206 that may be executed by processor 204 to perform any of the operations described herein. Instructions 206 may be implemented by any suitable application, software, code, and/or other executable data instance. Memory 202 may also maintain any data acquired, received, generated, managed, used, and/or transmitted by processor 204.

Processor 204 is configured to perform (e.g., execute instructions 206 stored in memory 202 to perform) various processing operations described herein. It will be recognized that the operations and examples described herein are merely illustrative of the many different types of operations that may be performed by processor 204. In the description herein, any references to operations performed by controller 136 may be understood to be performed by processor 204 of controller 136. Furthermore, in the description herein, any operations performed by controller 136 may be understood to include controller 136 directing, commanding, or instructing another system or device to perform the operations.

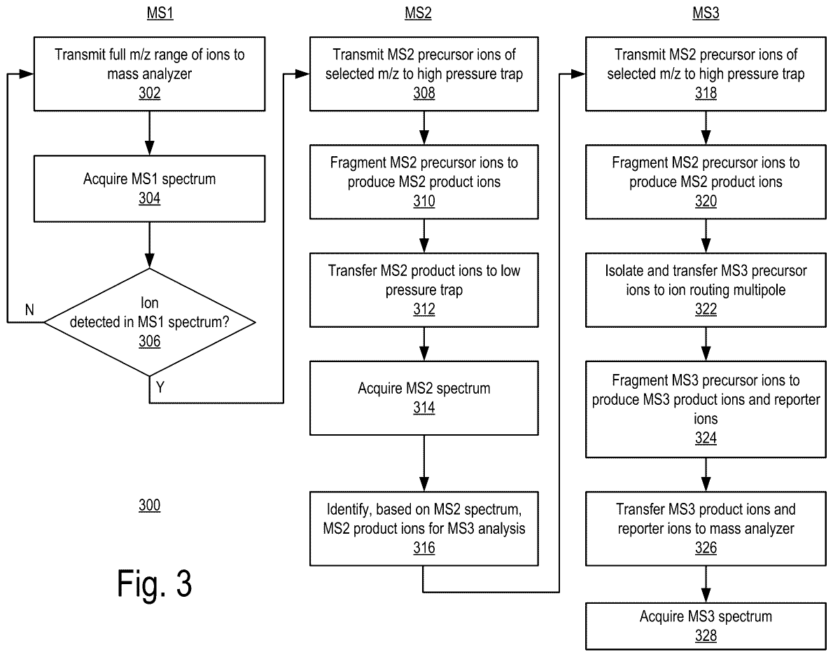

FIG. 3 shows an illustrative method 300 of performing an MS3 analysis of a sample using mass spectrometer 100. While FIG. 3 shows illustrative operations according to one embodiment, other embodiments may omit, add to, reorder, and/or modify any of the operations shown in FIG. 3. One or more of the operations shown in FIG. 3 may be performed by mass spectrometer 100, any components included therein (e.g., controller 136), and/or any implementations thereof.

In the example of method 300, the sample to be analyzed is a multiplex sample, which comprises a plurality of individual samples combined together. Each individual sample includes a plurality of analytes (e.g., peptides). Method 300 may be used to determine a relative quantity of a particular analyte across each of the individual samples. Accordingly, each individual sample is labeled with a unique isobaric mass tag. When an isobaric mass tag-labeled analyte ion is fragmented by MS3, as described below, the reporter region falls off and can be used for an MS3 analysis at each respective reporter ion m/z. The relative intensity of the reporter ions at their respective m/z are indicative of the relative quantities of the analyte from each individual sample. As will be explained below, method 300 improves the yield of MS3 product ions and reporter ions as compared with traditional methods, and thus improves the sensitivity and signal-to-noise ratio of the MS3 spectra. While method 300 is described with reference to multiplexing using isobaric mass tag-labeled analytes, method 300 can be used for techniques other than multiplexing and/or without isobaric mass tags.

At operations 302 to 306, mass spectrometer 100 is operated in MS1 mode to perform a full MS1 analysis (e.g., a survey scan). At operation 302, mass filter 118 is operated to transmit a full m/z range of ions to C-trap 120, which accumulates the ions and then transfers the accumulated ions to mass analyzer 122. At operation 304, mass analyzer 122 acquires an MS1 spectrum. At operation 306, controller 136 determines, based on the MS1 spectrum, if an ion is detected (e.g., when a detected signal level is equal to or greater than a threshold level). If an ion is detected, controller 136 switches mass spectrometer 100 to MS2 mode to perform an MS2 analysis of the ion and proceeds to operations 308 to 314. If an ion is not detected, processing returns to operation 302.

At operations 308 to 316, mass spectrometer 100 is operated in MS2 mode to perform an MS2 analysis of the ion. At operation 308, mass filter 118 is operated to selectively transmit MS2 precursor ions using a narrow isolation window (e.g., 1.2 m/z isolation width) encompassing a selected m/z for the MS2 precursor ions. The transmitted MS2 precursor ions are guided through C-trap 120 and ion routing multipole 124 to high pressure trap 128 for activation (fragmentation) of the MS2 precursor ions. At operation 310, the MS2 precursor ions are fragmented in high pressure trap 128 under high pressure to produce MS2 product ions. At operation 312, the MS2 product ions are transferred to low pressure trap 130. At operation 314, low pressure trap 130 performs a mass analysis of the MS2 product ions to acquire an MS2 spectrum. At operation 316, controller 136 identifies, based on the MS2 spectrum, MS2 product ions for MS3 analysis and switches mass spectrometer 100 to MS3 mode.

At operations 318 to 328, mass spectrometer 100 is operated in MS3 mode to perform an MS3 analysis of a select set of MS2 product ions (the MS3 precursor ions). At operation 318, mass filter 118 is operated to selectively transmit the MS2 precursor ions using a narrow isolation window (e.g., 2.5 m/z isolation width) encompassing the selected m/z for the MS2 precursor ions. The transmitted MS2 precursor ions are guided through C-trap 120 and ion routing multipole 124 to high pressure trap 128 for activation of the MS2 precursor ions. At operation 320, the MS2 precursor ions are fragmented in high pressure trap 128 under high pressure to produce MS2 product ions.

At operation 322, the set of MS3 precursor ions previously identified at operation 316 for MS3 analysis are isolated from the population of MS2 product ions and then subsequently transferred to ion routing multipole 124 for fragmentation and release of the reporter ion. The MS3 precursor ions may be isolated in any suitable way.

In some examples, such as in SPS MS3, the MS3 precursor ions are co-isolated using synchronous precursor selection to eject unwanted MS2 product ions. SPS isolation waveforms with multiple frequency notches are typically applied to the x-rods of the high pressure trap 128 to selectively eject the unwanted MS2 product ions from high pressure trap 128. The MS2 product ions that remain in high pressure trap 128 (the MS3 precursor ions) are then ejected in a single ejection event and transferred to ion routing multipole 124 using an appropriate DC voltage or combination of DC and RF voltages applied to transfer lens 132.

In other examples, the MS3 precursor ions are isolated from the population of MS2 product ions by a controlled elution of a plurality of packets of MS3 precursor ions from high pressure trap 128 over time in a plurality of distinct (separate) ejection events. Each packet of MS3 precursor ions has a distinct m/z and is ejected in a distinct ejection event. The packets of MS3 precursor ions may be eluted from high pressure trap 128 over time in any suitable way. For example, the DC voltage and/or the RF voltages applied to transfer lens 132 can be adjusted (e.g., ramped or stepped) over time to dynamically decrease the threshold m/z value so that MS3 precursor ions elute out of high pressure trap 128 over time in order of decreasing m/z. The packets of MS3 precursor ions are transferred to ion routing multipole 124 and accumulate in ion routing multipole 124.

The MS3 precursor ions may also be isolated from the population of MS2 product ions and ejected from high pressure trap 128 by other suitable techniques, including but not limited to mass-selective axial ejection. Mass-selective axial ejection of ions occurs when trapped ions are given some degree of radial excitation via a resonance excitation process, which gives the ions sufficient axial kinetic energy to overcome a static DC exit barrier or pseudopotential barrier.

At operation 324, the MS3 precursor ions accumulated in ion routing multipole 124 are fragmented upon transfer to ion routing multipole 124, thereby producing a population of MS3 product ions and a population of reporter ions. At operation 326, the population of MS3 product ions and the population of reporter ions are transferred to and accumulate in C-trap 120, which then transfers the accumulated ions to mass analyzer 122. At operation 328, mass analyzer 122 performs a mass analysis of the MS3 product ions and reporter ions to acquire an MS3 spectrum.

In many data dependent experiments, multiple ions (multiple ion species of distinct m/z values) are detected in the MS1 spectrum at operation 306 and selected (e.g., added to an acquisition list) for further analysis by MSn. Accordingly, after operation 328, operations 308 to 328 are repeated for the next selected ion. This process continues during one full cycle, which comprises the MS1 analysis (operations 302 to 306) followed by the MS2 and MS3 analyses (operations 308 to 328) for each selected ion. In some examples, the time to perform one cycle is fixed (e.g., 2 seconds, 3 seconds, etc.) and thus the number of detected ions selected for MSn analysis is limited by the available cycle time.

One of the limiting factors for the generation of reporter ion signal in conventional SPS MS3 experiments is that a compromise is made when setting the offset voltage for collisional activation of the MS3 precursors in ion routing multipole 124 (e.g., at operation 324). The compromise arises from the fact that, in conventional SPS MS3 methods, activation of the MS3 precursor ion population occurs in a single activation event using a fixed offset voltage. However, the optimum offset voltage for ion activation is m/z dependent (e.g., the offset voltage that has the most efficient fragmentation and/or produces the highest product ion intensity signal, within a tolerance (e.g., 3%, 5%, 10%)). In conventional SPS MS3 methods, the offset voltage for activation is chosen either based on an intensity-weighted average of the individual m/z values of the MS3 precursor ions (e.g., based on the MS2 spectrum) or based on the m/z value of the MS3 precursor ion having the highest observed intensity signal in the MS2 spectrum.

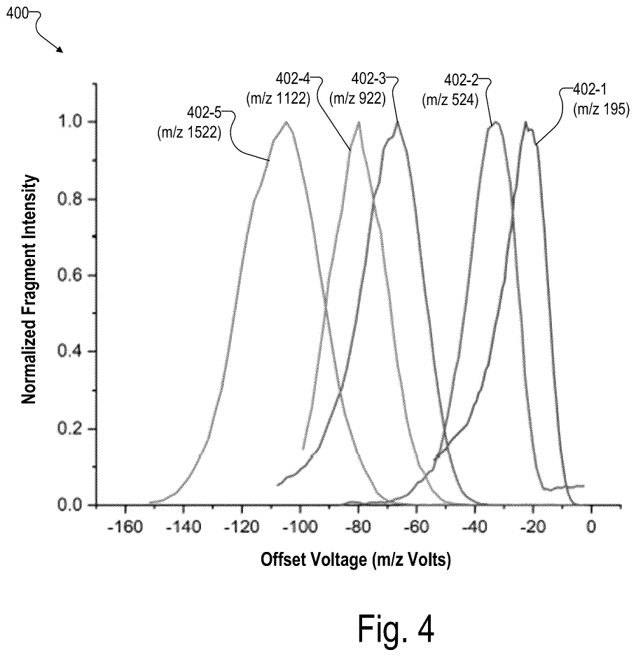

FIG. 4 shows a graph 400 that illustrates the m/z dependence of offset voltage. Graph 400 plots normalized fragment intensity as a function of offset voltage for a plurality of selected m/z. Graph 400 includes a curve 402-1 for m/z 195, a curve 402-2 for m/z 524, a curve 402-3 for m/z 922, a curve 402-4 for m/z 1122, and a curve 402-5 for m/z 1522. As can be seen in graph 400, curves 402 have narrow peaks with significant peak separation and poor peak overlap. Because of the narrow peaks and poor peak overlap, fragment yield will be poor for precursor ions which differ significantly in m/z from the m/z value used to choose the offset voltage. For example, assuming all selected m/z of FIG. 4 have the same intensity, the average m/z is 857, corresponding to an offset voltage value of about −60 V. However, at −60 V only m/z 922 produces any meaningful signal, thus indicating poor fragmentation yield of ions of the other m/z. In another example, assume that selection of the offset voltage is made based upon the highest observed intensity signal and that curves 402-1 and 402-2 had the highest intensity prior to normalization. Curves 402-1 and 402-2 overlap at a normalized signal intensity level of approximately 0.75 (corresponding to an offset voltage of about −30 V), but overlap with curves 402-3 and 402-4 at a normalized signal intensity level of approximately 0.2 or less (approximately −50 V) and do not overlap with curve 402-5. Accordingly, setting the offset voltage at approximately −30 V for m/z 195 and m/z 524 will result in poor fragment yield for ions having m/z 922, m/z 1122, and m/z 1522. For any given population of MS3 precursor ions, the amount of reduced fragment yield will depend on both the distribution of precursor m/z values from the m/z chosen to set the offset voltage and the respective intensities of the precursor m/z values and will vary acquisition to acquisition depending on the m/z selected for setting the offset voltage.

In method 300, these problems are overcome by dynamically adjusting the collision energy (e.g., by dynamically adjusting the offset voltage of ion routing multipole 124) based on m/z of the MS3 precursor ions as the MS3 precursor ions arrive at ion routing multipole 124 over time. The inventors observed that, as co-isolated MS3 precursor ions are transferred from high pressure trap 128 to ion routing multipole 124, the time-of-flight of co-isolated MS3 precursor ions from high pressure trap 128 to ion routing multipole 124 varies based on m/z of the MS3 precursor ions. Moreover, the elution of MS3 precursor ions out of high pressure trap 128, and hence the arrival time of the packets of MS3 precursor ions at ion routing multipole 124, can be controlled as desired. Accordingly, the collision energy for activating MS3 precursor ions in ion routing multipole 124 can be dynamically adjusted based on m/z of the packets of MS3 precursor ions as the packets of MS3 precursor ions arrive at ion routing multipole 124 over time.

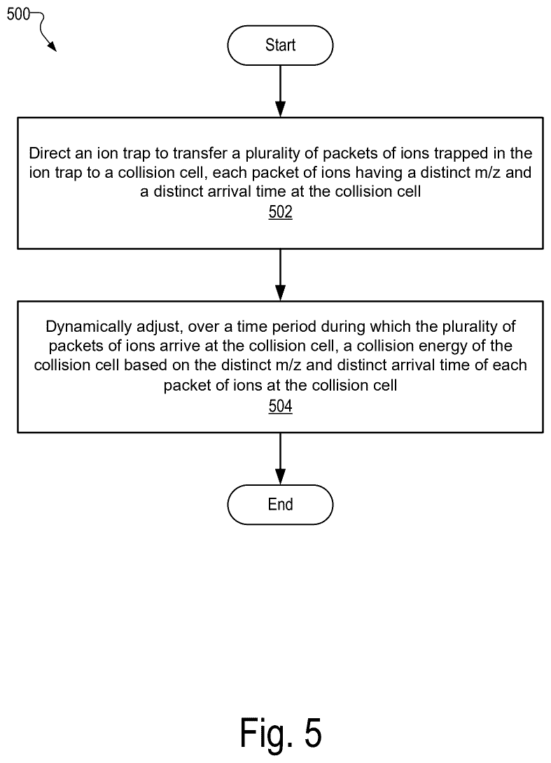

FIG. 5 shows an illustrative method 500 of dynamically setting the offset voltage of a collision cell based on m/z of ions as the ions arrive at the collision cell. While FIG. 5 shows illustrative operations according to one embodiment, other embodiments may omit, add to, reorder, and/or modify any of the operations shown in FIG. 5. One or more of the operations shown in FIG. 5 may be performed by mass spectrometer 100 or any components included therein (e.g., controller 136), and/or any other mass spectrometer in which precursor ions are transferred from an ion trap to a collision cell for activation of the precursor ions. In some examples, method 500 is performed in conjunction with method 300 to set the offset voltage of ion routing multipole 124 for operation 324.

At operation 502, an ion trap (e.g., high pressure trap 128 or low pressure trap 130) is directed to transfer a plurality of packets of ions trapped in the ion trap (e.g., MS3 precursor ions) to a collision cell (e.g., ion routing multipole 124 or high pressure trap 128). The ion trap may be any suitable ion trapping device. Each packet of ions has a distinct m/z and a distinct arrival time at the collision cell. The distinct m/z and the distinct arrival time are not necessarily discrete, as the distinct m/z may encompass an m/z range and the distinct arrival time may have a distribution of arrival times. Nevertheless, the m/z range and arrival time distribution are sufficiently narrow for performance of method 500. In examples where method 500 is used in conjunction with method 300, operation 502 corresponds to operation 322.

At operation 504, a collision energy of the collision cell is dynamically adjusted, over a time period during which the plurality of packets of ions arrive at the collision cell, based on the distinct m/z and the distinct arrival time of each packet of ions at the collision cell. In examples where method 500 is used in conjunction with method 300, operation 504 corresponds to operation 324.

Method 500 may be implemented in at least two different ways. A first method is based on an m/z-dependent arrival time at the collision cell of the plurality of packets of ions co-isolated and ejected in a single ejection event. A second method is based on a controlled elution of the plurality of packets of ions from the ion trap over time in a plurality of distinct ejection events, wherein each packet of ions is ejected in a distinct ejection event.

In the first method, the ion trap is directed to co-isolate the plurality of packets of ions and subsequently eject the plurality of packets of ions from the ion trap towards the collision cell in a single ejection event. When the transfer energy applied to the ion trap is fixed (e.g., DC voltage applied to high pressure trap 128 is fixed), the arrival time of the packets of ions at the collision cell is a function of m/z of the packets of ions. In some examples, the packets of ions are co-isolated using synchronous precursor selection by using an SPS isolation waveform with multiple frequency notches to discard unwanted ions and thus co-isolate the plurality of packets of desired ions in the ion trap, and the DC voltage is then adjusted to eject the co-isolated packets of ions in a single ejection event. Each distinct packet of ions corresponds to a distinct m/z (e.g., a distinct ion species) and, hence, a distinct m/z-dependent arrival time at the collision cell. The m/z-dependent arrival time is based on an m/z-dependent time-of-flight of each packet of ions from the ion trap to the collision cell.

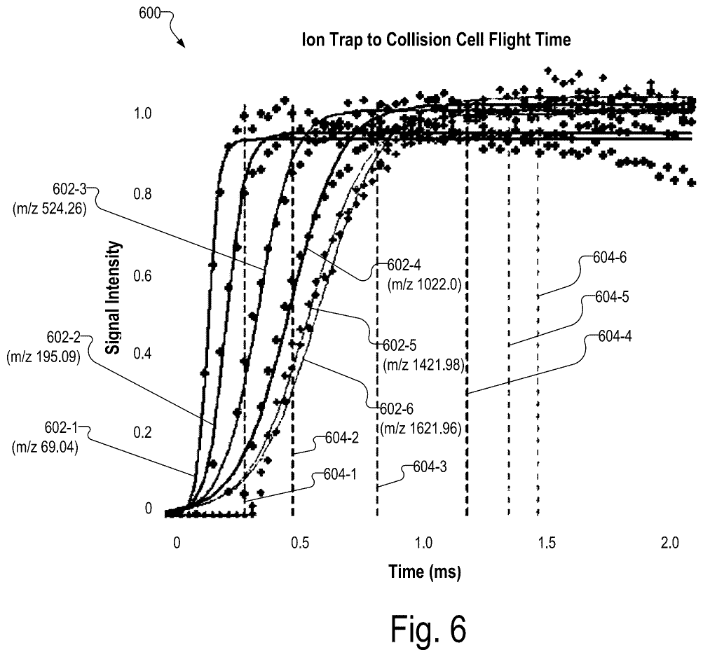

FIG. 6 shows a graph 600 that illustrates the m/z-dependence of the flight time of multiple distinct packets of ions (each containing ions of discrete m/z values) from high pressure trap 128 to ion routing multipole 124. Graph 600 includes a set of curves 602 (curves 602-1 to 602-6) that plot ion signal intensity, as observed by mass analyzer 122, as a function of time after ejection of ions from high pressure trap 128. The ion transfer time between various ion optical elements and devices in mass spectrometer 100 can be measured and calibrated, as is known in the art. Curve 602-1 plots flight time for ions of m/z 69.04, curve 602-2 plots flight time for ions of m/z 195.09, curve 602-3 plots flight time for ions of m/z 524.26, curve 602-4 plots flight time for ions of m/z 1022.00, curve 602-5 plots flight time for ions of m/z 1421.98, and curve 602-6 plots flight time for ions of m/z 1621.96. The arrival time of ions is indicated by dashed lines 604-1 to 604-6. As can be seen in graph 600, flight time increases as m/z increases.

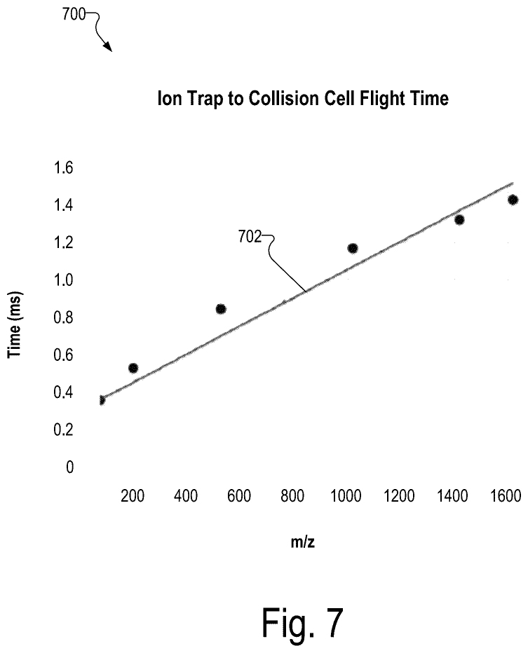

FIG. 7 shows a graph 700 that plots arrival time, as determined from graph 600 (e.g., lines 604-1 to 604-6), as a function of m/z. Graph 700 includes a curve 702 that is fit to the data points. Curve 702 is linear, but may also be a higher order polynomial function. As can be seen from graph 700, arrival time increases nearly proportionally with m/z and can be modeled as a function of m/z. Given that the optimal collision energy also increases nearly proportionally with m/z, the optimal collision energy can be increased as a function of time, as will be explained below in more detail. It should be noted that the optimal collision energy is increased prior to arrival of each respective packet of ions.

In the second method, the ion trap is directed to eject the plurality of packets of ions by eluting the plurality of packets of ions from the ion trap over a time period, as explained above with regard to operation 322. In some examples, eluting the plurality of packets of ions from the ion trap over the time period is performed by controlled ejection of the packets of ions in a plurality of distinct ejection events, with a distinct ejection event for each packet of ions. The distinct arrival time of each packet of ions is based at least in part on a timing of the corresponding ejection event. In some examples, the distinct arrival time of each packet of ions is also based on the flight time from the ion trap to the collision cell.

The packets of ions may be eluted from the ion trap over time in any suitable way. In some examples, the RF voltages applied to a transfer lens positioned at an exit of the ion trap (e.g., transfer lens 132 or lens 134) are adjusted over time (an ejection time period) to dynamically decrease the threshold m/z value of the pseudopotential barrier over time. As a result, ions elute out of the ion trap over time (during the ejection time period) in order of decreasing m/z. The packets of ions eluted out of the ion trap are transferred (guided) to and accumulate in the collision cell (e.g., ion routing multipole 124).

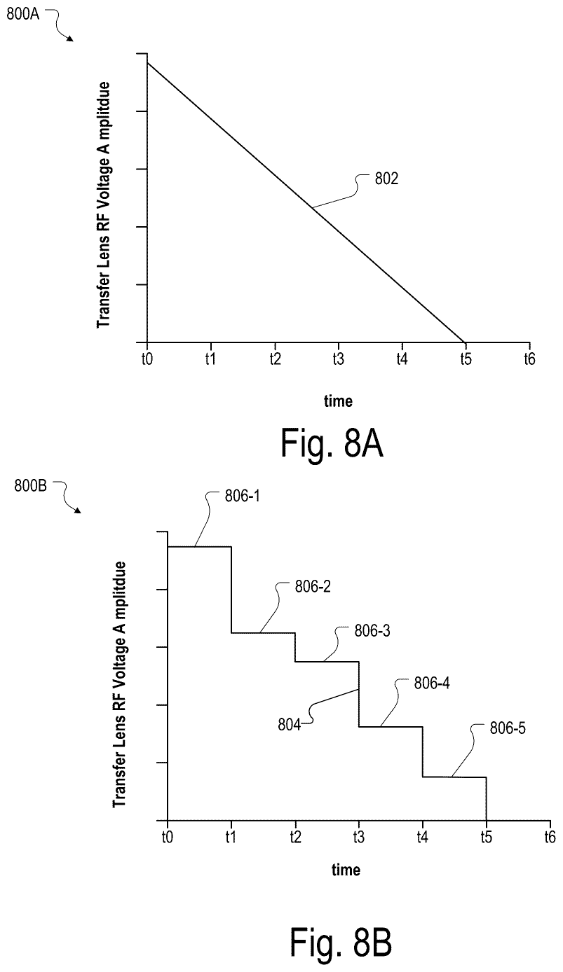

In some examples, the RF voltages applied to the transfer lens are adjusted over time by ramping down the amplitudes of the applied RF voltages in a continuous manner to smoothly decrease the threshold m/z value over time and, thus, smoothly decrease the m/z of ions that can elute from the ion trap over time. FIG. 8A shows an illustrative graph 800A including a curve 802 that plots the amplitude of the applied RF voltages as a function of time. Curve 802 shows that the amplitudes of the applied RF voltages are ramped down in a smooth, continuous manner. While curve 802 is linear, curve 802 may have any other continuous profile, such as a second-or higher-order polynomial. The slope of curve 802 is the elution rate and is the change in m/z per unit time. In some examples, an elution rate is set for elution of the population of ions from the ion trap, and the RF voltage applied to the transfer lens is ramped over time based on the elution rate. The elution rate can be set automatically (e.g., based on instrument parameters, scan speed, and/or the distribution in m/z of precursor ions) or can be set by a user. In some examples, the elution rate is a value between 20 m/z per millisecond (ms) and 200 m/z per ms, between 30 m/z per ms and 150 m/z per ms, between 40 m/z per ms and 100 m/z per ms, between 50 m/z per ms and 75 m/z per ms (all values inclusive), or any other suitable value. In some examples, the elution rate is set to achieve a minimum ejection resolution (e.g., a minimum amount of time between distinct ejection events for the set of precursor ions stored in the ion trap).

Moreover, given that ramping down the amplitudes of the applied RF voltages elutes ions in order of decreasing m/z and heavier ions (ions eluted earlier) have a longer time-of-flight to the collision cell (see FIG. 7), the elution rate can be configured to prevent lighter ions ejected in subsequent ejection events from arriving at the collision cell at roughly the same time as the heavier ions. This can be accomplished, for example, by configuring the elution rate to achieve a minimum arrival resolution (e.g., a minimum amount of time between distinct arrival events for distinct packets of ions). For instance, referring to the example of FIG. 7, m/z 1622 has a time-of-flight of 1.45 ms and m/z 1422 has a time-of-flight of 1.35 ms. Assuming an elution rate of 50 m/z per ms, ions of m/z 1622 will arrive at the collision cell approximately 3.9 ms before ions of m/z 1422. However, if the elution rate is 200 m/z per ms, ions of m/z 1622 will arrive at the collision cell approximately 0.9 ms before ions of m/z 1422, which may be too close in time for the instrument to adjust the offset voltage of the collision cell to optimize the offset voltage for both m/z 1622 and then m/z 1422. Accordingly, the elution rate may be set based on the instrument capabilities (e.g., offset voltage ramp speed and m/z-dependent flight times) and the distribution in m/z of the precursor ions to be transferred from the ion trap to the collision cell. In any event, the elution rate may be optimized based on the desired experimental outcome and may be set on a per-acquisition basis, as each mass spectrum acquisition will have a unique set of m/z values of MS3 precursor ions.

Alternatively to ramping down the amplitudes of the applied RF voltages in a continuous manner, the RF voltages applied to the transfer lens may be adjusted over time by stepping down the amplitudes of the applied RF voltages in a discontinuous manner to decrease the threshold m/z value in a series of steps. FIG. 8B shows an illustrative graph 800B including an elution curve 804 that plots the amplitude of the applied RF voltages as a function of time. Curve 804 is a step function that shows that the amplitudes of the applied RF voltages are stepped down in a series of steps 806 (e.g., steps 806-1 to 806-5), with a distinct step 806 for each distinct m/z (each distinct packet of ions). For example, referring to the example of FIG. 4, a first step 806-1 is configured for ejection of ions of m/z 1522, a second step 806-2 is configured for ejection of ions of m/z 1122, a third step 806-3 is configured for ejection of ions of m/z 922, a fourth step 806-4 is configured for ejection of ions of m/z 524, and a fifth step 806-5 is configured for ejection of ions of m/z 195. The step size and step duration can be adjusted as desired. In some examples, intermediate steps (steps that do not correspond to any precursor ion of interest) can be set between any two steps 806. In yet further examples, the amplitudes of the applied RF voltages can be ramped down continuously, as in FIG. 8A, between any two steps 806.

In the examples described above, the packets of ions are eluted from the ion trap over time by dynamically adjusting (e.g., ramping or stepping) the RF voltages applied to the transfer lens. In alternative examples, the packets of ions are eluted from the ion trap over time by dynamically adjusting (e.g., ramping or stepping) the DC voltages applied to the ion trap to urge trapped ions to migrate out of the ion trap. In yet further examples, the packets of ions are eluted from the ion trap over time by dynamically adjusting (e.g., ramping or stepping) both the RF voltages applied to the transfer lens and the DC voltages applied to the ion trap.

By ejecting a plurality of distinct packets of ions in a plurality of distinct ejection events, each distinct packet of ions arrives at the collision cell at a distinct time. Thus, the collision energy of the collision cell can be optimized for the m/z of the arriving packet of ions.

In both the first method and the second method of implementing method 500, the collision energy of the collision cell is dynamically adjusted based on the distinct m/z of each packet of ions and the distinct arrival time of each packet of ions at the collision cell. The collision energy may be dynamically adjusted in any suitable way. In some examples, dynamically adjusting the collision energy of the collision cell includes adjusting (e.g., optimizing) the offset voltage of the collision cell based on the distinct m/z of each packet of ions and the distinct arrival time of each packet of ions at the collision cell. For example, as shown in FIG. 7, ions of m/z 69 arrive at the collision cell approximately 0.35 ms after ejection. Accordingly, an optimal offset voltage for m/z 69 is applied to the collision cell approximately 0.35 ms after the ejection event for ions of m/z 69. Similarly, ions of m/z 195 arrive at the collision cell approximately 0.50 ms after ejection. Accordingly, an optimal offset voltage for m/z 195 is applied to the collision cell approximately 0.50 ms after the ejection event for ions of m/z 195. Using the known or measured m/z-dependent arrival time of the precursor ions at the collision cell, the optimal offset voltage of the collision cell over time can be scheduled based on (or synchronized with) the m/z of each packet of ions as the packet of ions arrives at the collision cell. The offset voltages are then applied to the collision cell based on the offset voltage schedule. In this way, the collision energy can be optimized for each packet of ions to be activated in the collision cell.

As used herein, “optimize” and its variants means to seek a best, desired, or satisfactory solution among a set of possible solutions, although the best solution may not necessarily be obtained, such as when an optimization process is terminated (e.g., based on satisfaction of a stop criterion) prior to finding the best solution, when multiple solutions exist that satisfy predefined criteria, or when a selected optimization technique is unable to converge on the best solution. Similarly, as used herein an “optimum” parameter, including a “maximum” or “minimum” parameter, means the solution obtained as the result of performing an optimization process, and thus may not necessarily be the absolute extreme value of the parameter (e.g., the absolute maximum or minimum), but still adjusts the parameter and results in an improvement and/or satisfies one or more criteria.

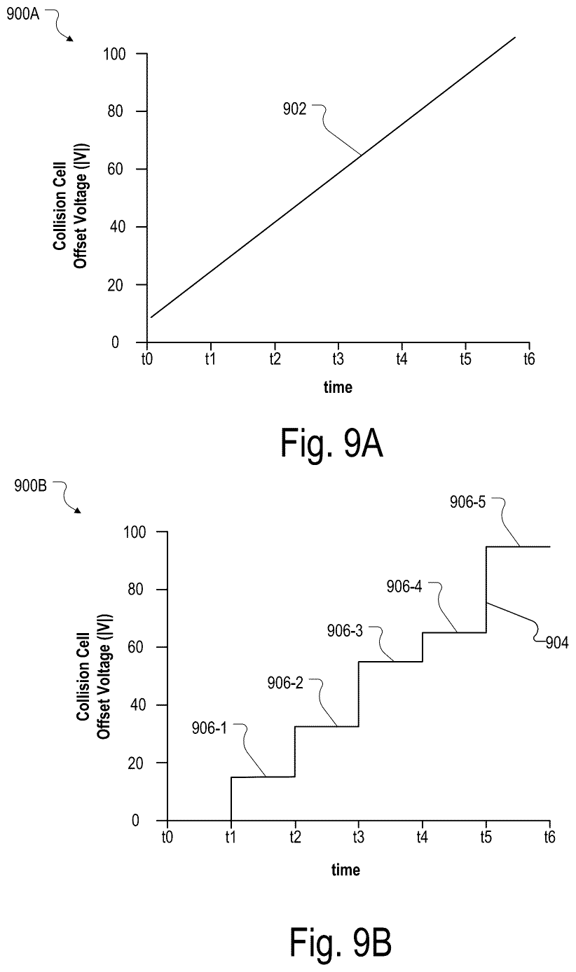

In some examples, the offset voltage schedule ramps the offset voltage in a continuous manner over time to smoothly increase the collision energy over time. FIG. 9A shows an illustrative offset voltage schedule 900A for continuously adjusting the offset voltage of the collision cell over time. Offset voltage schedule 900A is represented by a curve 902 that plots offset voltage as a function of time. As shown, offset voltage schedule 900A linearly ramps the offset voltage over time. In some examples, offset voltage schedule 900A is generated based on the optimal offset voltage for each m/z of interest (precursor ion of interest) and the m/z-dependent arrival time of the precursor ions of interest. For instance, curve 702 of graph 700 may be used in conjunction with data representative of the m/z-dependent offset voltage to generate a function representing offset voltage as a function of time (e.g., curve 902). In some examples, the optimal offset voltage for each packet of ions is determined by optimizing the function, such as by finding a curve with a best fit. For example, curve 902 may represent a best fit to a set of data that plot optimum offset voltage versus time. As a result, the scheduled offset voltage for each packet of arriving ions, as determined by the function (e.g., curve 902), may not necessarily produce the highest product ion yield for each precursor ion of interest.

In other examples, the offset voltage schedule steps the offset voltage discontinuously to adjust the collision energy in a stepwise manner over time. FIG. 9B shows an illustrative offset voltage schedule 900B for stepping the offset voltage of the collision cell over time. Offset voltage schedule 900B is represented by a line 904 that plots offset voltage as a function of time. As shown, line 904 includes a plurality of steps 906 (e.g., steps 906-1 to 906-5) to step the offset voltage over time. Each step corresponds to an offset voltage (e.g., an optimal offset voltage) for the ions of interest that are expected to arrive at the collision cell during each step time.

When the ions are ejected in a single ejection event, as in SPS MS3 experiments, precursor ions arrive at the collision cell during an arrival time period in order of increasing m/z. Accordingly, the offset voltage is dynamically increased (ramped up or stepped up) over the arrival time period. On the other hand, when the ions are ejected in a plurality of distinct ejection events, such as by dynamically adjusting the RF voltages applied to the transfer lens over time to adjust the pseudopotential barrier over time, as described above, ions arrive at the collision cell in order of decreasing m/z. Accordingly, the offset voltage is dynamically decreased (ramped down or stepped down) over the arrival time period.

In some examples, the optimal offset voltages and distinct m/z-dependent arrival times for precursor ions of interest for a particular experiment are accessed from a local or remote library or database. In some examples, the stored optimal offset voltages and arrival times are further based on experiment and/or instrument parameters, such as instrument hardware types and configuration, distance traveled, temperature, pressure, and voltage applied to the ion trap to accelerate the ions. Additionally or alternatively, the optimal offset voltages and distinct m/z-dependent arrival times for the particular experiment are measured on the same instrument setup prior to performing the experiment. The known or measured optimal offset voltages and m/z-dependent arrival times can then be used during the experiment to generate an offset voltage schedule. In some examples, or can be added to a library of optimal offset voltages and m/z-dependent arrival times.

In some cases, the collision energy of the collision cell cannot be adjusted fast enough over time, due to instrument limitations, to optimize the collision energy for each packet of arriving precursor ions, such as in SPS MS3 techniques where the packets of ions are ejected in a single event and thus might arrive in close succession. In these cases, the second method can be selected to slow down the experiment by eluting the packets of ions over a longer time period (the ejection time period) that allows the collision energy to be dynamically over time to optimize the offset voltage for each arriving packet of precursor ions. For instance, at an elution rate of 100 m/z per ms, the relevant m/z range for the SPS MS3 precursor ions (e.g., 400-2000 m/z) could be eluted in approximately 16 ms. While reduction in scan duty cycle seems undesirable, the reduced scan duty can be offset by using the increased signal-to-noise ratio in the reporter ion yield to reduce the maximum injection time into the ion trap (e.g., high pressure trap 128) or collision cell for the experiment. Thus, at least the same or a better signal-to-noise ratio can be obtained as compared with currently available SPS MS3 techniques but at a reduced maximum injection time.

The systems and methods described above are not limited to SPS MS3 or other MS3 techniques, but can be applied to any experiment where an ensemble of cooled, trapped ions needs to undergo higher-energy collisional dissociation (HCD) activation, such as in a multiplex MS2 experiment where ions are isolated either sequentially with a quadrupole mass filter or concurrently with an isolation waveform. For example, where MS2 precursor ions are isolated sequentially over time, the collision energy of the collision cell can be dynamically optimized for the m/z of the MS2 precursor ions as the MS2 precursor ions arrive at the collision cell over time. Such a procedure would not require slewing of the DC offset voltages applied to the collision cell while the MS2 precursor ions are transferred from the mass filter to the ion routing multipole.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

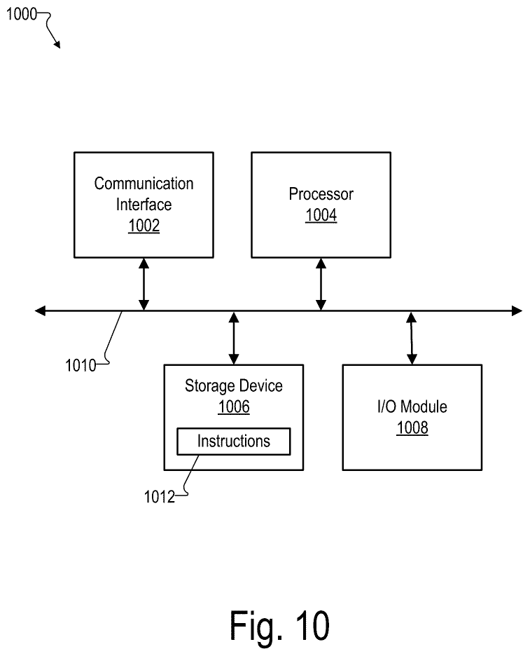

FIG. 10 shows an illustrative computing device 1000 that may be specifically configured to perform one or more of the processes described herein. As shown in FIG. 10, computing device 1000 may include a communication interface 1002, a processor 1004, a storage device 1006, and an input/output (“I/O”) module 1008 communicatively connected one to another via a communication infrastructure 1010. While an illustrative computing device 1000 is shown in FIG. 10, the components illustrated in FIG. 10 are not intended to be limiting. Additional or alternative components may be used in other embodiments. Components of computing device 1000 shown in FIG. 10 will now be described in additional detail.

Communication interface 1002 may be configured to communicate with one or more computing devices. Examples of communication interface 1002 include, without limitation, a wired network interface (such as a network interface card), a wireless network interface (such as a wireless network interface card), a modem, an audio/video connection, and any other suitable interface.

Processor 1004 generally represents any type or form of processing unit capable of processing data and/or interpreting, executing, and/or directing execution of one or more of the instructions, processes, and/or operations described herein. Processor 1004 may perform operations by executing computer-executable instructions 1012 (e.g., an application, software, code, and/or other executable data instance) stored in storage device 1006.

Storage device 1006 may include one or more data storage media, devices, or configurations and may employ any type, form, and combination of data storage media and/or device. For example, storage device 1006 may include, but is not limited to, any combination of the non-volatile media and/or volatile media described herein. Electronic data, including data described herein, may be temporarily and/or permanently stored in storage device 1006. For example, data representative of computer-executable instructions 1012 configured to direct processor 1004 to perform any of the operations described herein may be stored within storage device 1006. In some examples, data may be arranged in one or more databases residing within storage device 1006.

I/O module 1008 may include one or more I/O modules configured to receive user input and provide user output. One or more I/O modules may be used to receive input for a single virtual experience. I/O module 1008 may include any hardware, firmware, software, or combination thereof supportive of input and output capabilities. For example, I/O module 1008 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1008 is configured to provide graphical data to a display for presentation to a user. The graphical data may be representative of one or more graphical user interfaces and/or any other graphical content as may serve a particular implementation.

In some examples, any of the systems, computing devices, and/or other components described herein may be implemented by computing device 1000. For example, memory 202 may be implemented by storage device 1006, and processor 204 may be implemented by processor 1004.

It will be recognized by those of ordinary skill in the art that while, in the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

Advantages and features of the present disclosure can be further described by the following examples:

Example 1. A system for mass spectrometry, comprising: one or more processors; and memory storing executable instructions that, when executed by the one or more processors, cause a computing device for mass spectrometry to perform a process comprising: directing an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjusting, over a time period during which the plurality of packets of ions arrive at the collision cell, a collision energy of the collision cell based on the distinct m/z of each packet of ions and the distinct arrival time of each packet of ions at the collision cell.

Example 2. The system of example 1, wherein the dynamically adjusting the collision energy of the collision cell is further based on an optimal collision energy for the distinct m/z of each packet of ions.

Example 3. The system of example 1, wherein the dynamically adjusting the collision energy of the collision cell comprises ramping, over the time period, an offset voltage applied to the collision cell.

Example 4. The system of example 1, wherein the dynamically adjusting the collision energy of the collision cell comprises stepping, over the time period by a plurality of steps, an offset voltage applied to the collision cell.

Example 5. The system of example 1, wherein: the directing the ion trap to transfer the plurality of packets of ions to the collision cell comprises ejecting the plurality of packets of ions from the ion trap in a single ejection event; and the distinct arrival time of each packet of ions is based on an m/z-dependent time-of-flight of each packet of ions from the ion trap to the collision cell.

Example 6. The system of example 5, wherein the dynamically adjusting the collision energy of the collision cell over the time period comprises ramping up the collision energy of the collision cell as a function of time.

Example 7. The system of example 1, wherein: the directing the ion trap to transfer the plurality of packets of ions to the collision cell comprises directing the ion trap to elute the plurality of packets of ions from the ion trap over an additional time period.

Example 8. The system of example 7, wherein: the eluting the plurality of packets of ions from the ion trap over the additional time period comprises ejecting the plurality of packets of ions in a plurality of ejection events during the additional time period; the plurality of ejection events comprise a distinct ejection event for each packet of ions; and the distinct arrival time of each packet of ions is based at least in part on a timing of each distinct ejection event.

Example 9. The system of example 7, wherein the eluting the plurality of packets of ions from the ion trap over the additional time period comprises: applying an RF voltage to a transfer lens positioned at an exit of the ion trap to generate a pseudo-potential barrier that prevents ions having an m/z less than a threshold m/z value from exiting the ion trap; and ramping down the applied RF voltage over the additional time period to decrease the threshold m/z value.

Example 10. The system of example 9, wherein the process further comprises: determining an elution rate for elution of the plurality of packets of ions from the ion trap; and ramping the RF voltage over time based on the elution rate.

Example 11. The system of example 10, wherein the elution rate ranges from 50 m/z per millisecond to 200 m/z per millisecond.

Example 12. The system of example 7, wherein eluting the plurality of packets of ions from the ion trap comprises: applying an RF voltage to a transfer lens positioned at an exit of the ion trap to generate a pseudo-potential barrier that prevents ions having an m/z less than a threshold m/z value from exiting the ion trap; and stepping down the applied RF voltage in a plurality of steps over the ejection time period to decrease the threshold m/z value.

Example 13. The system of example 1, wherein each packet of ions comprises a packet of MS3 precursor ions labeled with a distinct isobaric tag.

Example 14. The system of example 13, wherein directing the ion trap to transfer the plurality of packets of ions to the collision cell comprises: co-isolating, from a population of MS2 fragment ions, the plurality of packets of MS3 precursor ions by synchronous precursor selection (SPS).

Example 15. The system of example 14, wherein: the dynamically adjusting the collision energy of the collision cell causes fragmentation of the ions included in the plurality of packets of ions to generate a population of MS3 product ions and a population of reporter ions derived from the isobaric tags; and the process further comprises: transferring the population of MS3 product ions and the population of reporter ions to a mass analyzer; and mass analyzing the population of MS3 product ions and the population of reporter ions.

Example 16. A mass spectrometer comprising: an ion trap; a collision cell; and a controller configured to: direct an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjust, over a time period during which the plurality of packets of ions arrive at the collision cell, a collision energy of the collision cell based on the distinct m/z of each packet of ions and the distinct arrival time of each packet of ions at the collision cell.

Example 17. The mass spectrometer of example 16, wherein: the ion trap comprises a high pressure trap included in a dual cell linear quadrupole ion trap; and the collision cell comprises an ion routing multipole.

Example 18. The mass spectrometer of example 17, further comprising a transfer lens positioned at an exit of the ion trap, wherein: a power source is configured to apply an RF voltage to the transfer lens to generate a pseudo-potential barrier that prevents ions having an m/z less than a threshold m/z value from exiting the ion trap; and the directing the ion trap to transfer the plurality of packets of ions to the collision cell comprises directing the ion trap to ramp down the RF voltage applied to the transfer lens over an ejection time period to decrease the threshold m/z value.

Example 19. The mass spectrometer of example 16, further comprising a mass analyzer, wherein: the plurality of packets of ions are fragmented in the collision cell to produce a population of product ions; and the controller is further configured to direct the collision cell to transfer the population of product ions to the mass analyzer for a mass analysis of the product ions.

Example 20. A non-transitory computer-readable medium storing instructions that, when executed, direct at least one processor of a computing device for mass spectrometry to perform a process comprising: directing an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and dynamically adjusting, over a time period during which the plurality of packets of ions arrive at the collision cell, a collision energy of the collision cell based on the distinct m/z of each packet of ions and the distinct arrival time of each packet of ions at the collision cell.

What is claimed is:

1. A system for mass spectrometry, comprising:
one or more processors; and
memory storing executable instructions that, when executed by the one or more processors, cause a computing device for mass spectrometry to perform a process comprising:
directing an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and
dynamically adjusting, over a time period during which the plurality of packets of ions arrive at the collision cell, a collision energy of the collision cell based on the distinct m/z of each packet of ions and the distinct arrival time of each packet of ions at the collision cell.

2. The system of claim 1, wherein the dynamically adjusting the collision energy of the collision cell is further based on an optimal collision energy for the distinct m/z of each packet of ions.

3. The system of claim 1, wherein the dynamically adjusting the collision energy of the collision cell comprises ramping, over the time period, an offset voltage applied to the collision cell.

4. The system of claim 1, wherein the dynamically adjusting the collision energy of the collision cell comprises stepping, over the time period by a plurality of steps, an offset voltage applied to the collision cell.

5. The system of claim 1, wherein:
the directing the ion trap to transfer the plurality of packets of ions to the collision cell comprises ejecting the plurality of packets of ions from the ion trap in a single ejection event; and
the distinct arrival time of each packet of ions is based on an m/z-dependent time-of-flight of each packet of ions from the ion trap to the collision cell.

6. The system of claim 5, wherein the dynamically adjusting the collision energy of the collision cell over the time period comprises ramping up the collision energy of the collision cell as a function of time.

7. The system of claim 1, wherein:
the directing the ion trap to transfer the plurality of packets of ions to the collision cell comprises directing the ion trap to elute the plurality of packets of ions from the ion trap over an additional time period.

8. The system of claim 7, wherein:
the eluting the plurality of packets of ions from the ion trap over the additional time period comprises ejecting the plurality of packets of ions in a plurality of ejection events during the additional time period;
the plurality of ejection events comprise a distinct ejection event for each packet of ions; and
the distinct arrival time of each packet of ions is based at least in part on a timing of each distinct ejection event.

9. The system of claim 7, wherein the eluting the plurality of packets of ions from the ion trap over the additional time period comprises:
applying an RF voltage to a transfer lens positioned at an exit of the ion trap to generate a pseudo-potential barrier that prevents ions having an m/z less than a threshold m/z value from exiting the ion trap; and
ramping down the applied RF voltage over the additional time period to decrease the threshold m/z value.

10. The system of claim 9, wherein the process further comprises:
determining an elution rate for elution of the plurality of packets of ions from the ion trap; and
ramping the RF voltage over time based on the elution rate.

11. The system of claim 10, wherein the elution rate ranges from 50 m/z per millisecond to 200 m/z per millisecond.

12. The system of claim 7, wherein eluting the plurality of packets of ions from the ion trap comprises:
applying an RF voltage to a transfer lens positioned at an exit of the ion trap to generate a pseudo-potential barrier that prevents ions having an m/z less than a threshold m/z value from exiting the ion trap; and
stepping down the applied RF voltage in a plurality of steps over the additional time period to decrease the threshold m/z value.

13. The system of claim 1, wherein each packet of ions comprises a packet of MS3 precursor ions labeled with a distinct isobaric tag.

14. The system of claim 13, wherein directing the ion trap to transfer the plurality of packets of ions to the collision cell comprises:
co-isolating, from a population of MS2 fragment ions, the plurality of packets of MS3 precursor ions by synchronous precursor selection (SPS).

15. The system of claim 14, wherein:
the dynamically adjusting the collision energy of the collision cell causes fragmentation of the ions included in the plurality of packets of ions to generate a population of MS3 product ions and a population of reporter ions derived from the isobaric tags; and
the process further comprises:
transferring the population of MS3 product ions and the population of reporter ions to a mass analyzer; and
mass analyzing the population of MS3 product ions and the population of reporter ions.

16. A mass spectrometer comprising:
an ion trap;
a collision cell; and
a controller configured to:
direct an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and
dynamically adjust, over a time period during which the plurality of packets of ions arrive at the collision cell, a collision energy of the collision cell based on the distinct m/z of each packet of ions and the distinct arrival time of each packet of ions at the collision cell.

17. The mass spectrometer of claim 16, wherein:
the ion trap comprises a high pressure trap included in a dual cell linear quadrupole ion trap; and
the collision cell comprises an ion routing multipole.

18. The mass spectrometer of claim 17, further comprising a transfer lens positioned at an exit of the ion trap, wherein:
a power source is configured to apply an RF voltage to the transfer lens to generate a pseudo-potential barrier that prevents ions having an m/z less than a threshold m/z value from exiting the ion trap; and
the directing the ion trap to transfer the plurality of packets of ions to the collision cell comprises directing the ion trap to ramp down the RF voltage applied to the transfer lens over an ejection time period to decrease the threshold m/z value.

19. The mass spectrometer of claim 16, further comprising a mass analyzer, wherein:
the plurality of packets of ions are fragmented in the collision cell to produce a population of product ions; and
the controller is further configured to direct the collision cell to transfer the population of product ions to the mass analyzer for a mass analysis of the product ions.

20. A non-transitory computer-readable medium storing instructions that, when executed, direct at least one processor of a computing device for mass spectrometry to perform a process comprising:
directing an ion trap to transfer a plurality of packets of ions accumulated in the ion trap to a collision cell, wherein each packet of ions of the plurality of packets of ions has a distinct mass-to-charge ratio (m/z) and a distinct arrival time at the collision cell; and
dynamically adjusting, over a time period during which the plurality of packets of ions arrive at the collision cell, a collision energy of the collision cell based on the distinct m/z of each packet of ions and the distinct arrival time of each packet of ions at the collision cell.
